(19) United States
(12) Patent Application Publication
(10) Pub. No.: US 2005/0120265 A1
(43) Pub. Date: Jun. 2, 2005

(54) Data storage system with error correction code and replaceable defective memory

(76) Inventors: Steven L. Pline, Boise, ID (US); Kenneth Kay Smith, Boise, ID (US); Colin Andrew Stobbs, Eagle, ID (US); Stewart Wyatt, Boise, ID (US); David Murray Banks, Bristol (GB); Robin Alexis Takasugi, Eagle, ID (US); David McIntyre, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/725,855

(22) Filed: Dec. 2, 2003

(51) Int. Cl. G06F 11/00

(52) U.S. Cl. 714/7; 714/746

(57) ABSTRACT

Embodiments of the present invention provide a data storage and retrieval system operating on a host computer. The data storage and retrieval system comprises a sparing system configured to replace defective memory sections of a memory device with replacement memory sections of the memory device, and an error correction code system. The error correction code system is configured to encode data with an error correction code to store the data into the memory device and decode the encoded data with the error correction code to retrieve the data from the memory device.

### BACKGROUND

An increasing number of electronic systems use non-volatile memory with ever-larger storage capacities. One type of non-volatile memory known in the art includes magnetic memory cells. These devices, known as magnetic random access memory (MRAM) devices, include one or more arrays of magnetic memory cells. The magnetic memory cells may be of different types. For example, the memory cells can be magnetic tunnel junction (MTJ) memory cells or giant magnetoresistive (GMR) memory cells.

Generally, a magnetic memory cell includes a layer of magnetic film in which the orientation of magnetization is alterable and a layer of magnetic film in which the orientation of magnetization may be fixed or “pinned” in a particular direction. The magnetic film having alterable magnetization is referred to as a sense layer or data storage layer and the magnetic film that is fixed is referred to as a reference layer or pinned layer.

Conductive traces referred to as word lines and bit lines are routed across an array of memory cells. Word lines extend along rows of the memory cells, and bit lines extend along columns of the memory cells. A bit of information is stored in a memory cell as an orientation of magnetization in the sense layer at each intersection of a word line and a bit line. The orientation of magnetization in the sense layer aligns along an axis of the sense layer referred to as its easy axis. Magnetic fields are applied to flip the orientation of magnetization in the sense layer along its easy axis to either a parallel or anti-parallel orientation with respect to the orientation of magnetization in the reference layer.

The word lines and bit lines routed across the array of memory cells can be used to flip the orientation of magnetization in sense layers. The word lines extend along rows of the memory cells near the sense layers, and the bit lines extend along columns of the memory cells near the reference layers. The word lines and bit lines are electrically coupled to a write circuit.

During a write operation, the write circuit selects one word line and one bit line to change the orientation of magnetization in the sense layer of the memory cell situated at the conductors' crossing point. The write circuit supplies write currents to the selected word line and bit line to create magnetic fields in the selected memory cell. The magnetic fields combine to set or switch the orientation of magnetization in the selected memory cell.

The resistance through a memory cell differs according to the parallel or anti-parallel orientation of magnetization of the sense layer and the reference layer. The resistance is highest when the orientation is anti-parallel, which can be referred to as the logic “1” state, and lowest when the orientation is parallel, which can be referred to as the logic “0” state. The resistive state of the memory cell can be determined by sensing the resistance through the memory cell.

In one configuration, word lines and bit lines are used in sensing the resistance through a memory cell. Word lines are electrically coupled to sense layers and bit lines are electrically coupled to reference layers. Word lines and bit lines are electrically coupled to a read circuit to sense the resistive state of a memory cell.

During a read operation, the read circuit selects one word line and one bit line to sense the resistance through the memory cell situated at the conductors' crossing point. In one type of read operation, the read circuit supplies a constant sense voltage across the selected memory cell to generate a sense current through the memory cell. The sense current through the memory cell is proportional to the resistance through the memory cell and is used to differentiate a high resistive state from a low resistive state.

Although a magnetic memory is generally reliable, failures can occur that affect the ability of memory cells to store data. Failures can result from many causes including manufacturing imperfections, internal effects such as noise during a read operation, environmental effects such as temperature and surrounding electromagnetic noise, and aging of the magnetic memory. A memory cell affected by a failure can become unusable, such that no logical value can be read from the memory cell or the logical value read from the memory cell is not necessarily the same as the logical value written to the memory cell. The storage capacity and reliability of the magnetic memory can be severely affected and in the worst case the entire magnetic memory becomes unusable. Hence, techniques are being developed that respond to failures and reduce loss of capacity.

### SUMMARY

Embodiments of the present invention provide a magnetic memory data storage and retrieval system operable on a host computer. The system comprises a sparing system configured to replace defective memory sections of a magnetic memory device with replacement memory sections of the magnetic memory device, and an error correction code system. The error correction code system is configured to encode data with an error correction code to store the data into the magnetic memory device and decode the encoded data with the error correction code to retrieve the data from the magnetic memory device.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a diagram illustrating an exemplary embodiment of an electronic system, according to the present invention.

FIG. 2 is a diagram illustrating an exemplary embodiment of a storage device.

FIG. 3 is a diagram illustrating an exemplary embodiment of an array section.

FIG. 4 is a diagram illustrating another magnetic memory storage device.

FIG. 5 is a diagram illustrating an exemplary logical data structure for ECC encoded data stored in arrays using a Reed-Solomon ECC scheme.

FIG. 6A is a diagram illustrating a write path of the exemplary embodiment for storing data in a storage device.

FIG. 6B is a diagram illustrating a read path of the exemplary embodiment for retrieving data from a storage device.

FIG. 7 is a flow chart illustrating a write operation.

FIG. 8 is a flow chart illustrating a read operation.

### DETAILED DESCRIPTION

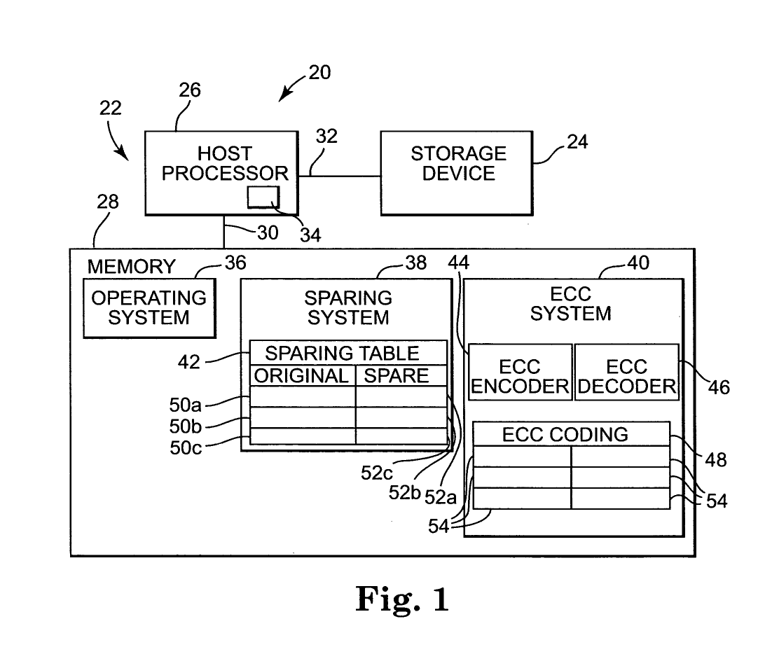

FIG. 1 is a diagram illustrating an exemplary embodiment of an electronic system 20, according to the present invention. The electronic system 20 includes a host computer system 22 and a storage device 24. The host computer system 22 includes a host processor 26 and host memory 28. The host processor 26 is electrically coupled to host memory 28 through conductive host memory paths, indicated at 30, and to storage device 24 through conductive storage device input/output (I/O) paths, indicated at 32. The electronic system 20 can be any suitable system, such as a digital camera or a personal digital assistant (PDA).

The host computer system 22 stores data into and retrieves data from storage device 24. The host computer system 22 replaces defective sections of memory in storage device 24 with replacement sections of memory in storage device 24. The replacement memory sections are used in place of the defective memory sections. The defective memory sections are not used. The replacement memory sections are spare sections of memory in storage device 24. The process of replacing defective memory sections with spare memory sections is referred to as sparing or sparing out the defective memory sections. In addition, host computer system 22 includes an error correction code (ECC) scheme for encoding data stored in storage device 24 and decoding encoded data retrieved from storage device 24. The host computer system 22 uses the ECC scheme to correct errors in data retrieved from storage device 24.

The host processor 26 includes random access memory (RAM) 34 and executes computer readable instructions out of RAM 34 to perform functions of electronic system 20. In addition, host processor 26 uses RAM 34 as a scratch pad and for temporary storage. In the exemplary embodiment, host processor 26 is a microprocessor including RAM 34. In other embodiments, host processor 26 can be any suitable processing unit, such as a microcontroller or state machine controller, or multiple processing units.

Storage device 24 is a memory device that writes data into write addresses received from host processor 26 and reads data from read addresses received from host processor 26. Storage device 24 is referred to herein as a storage style memory device. In one exemplary embodiment, sparing and ECC functions are provided by host computer 22. In the exemplary embodiment, storage device 24 is a storage style MRAM. In other embodiments, the storage device can be another suitable storage style memory device, such as a phase change random access memory (PCRAM).

The host memory 28 is a computer readable medium that stores computer readable instructions executed by host processor 26. The computer readable instructions stored in host memory 28 include an operating system 36, a sparing system 38 and an ECC system 40. The sparing system 38 includes a sparing table 42, and the ECC system includes an ECC encoder 44, an ECC decoder 46 and an ECC coding table 48. In other embodiments, all or part of the operating system 36, sparing system 38 and/or ECC system 40 can be stored in storage device 24 and/or other memory devices.

In the exemplary embodiment, host memory 28 is an electrically erasable programmable read only memory (EEPROM). In other embodiments, the host memory can be any suitable computer readable medium, such as Flash EEPROM, magnetic floppy discs, magnetic hard discs, read only memory (ROM), compact discs (CDs), digital video discs (DVDs), battery backed RAM, MRAM and PCRAM. In these embodiments, all or part of operating system 36, sparing system 38 and/or ECC system 40 can be stored in the host memory, storage device 24 and/or other memory devices.

The operating system 36 is a group of computer readable instructions that organize and control operation of electronic system 20. The operating system 36 includes instructions that provide a sequence of operation for functions provided by electronic system 20. In one embodiment, electronic system 20 is a digital camera and operating system 36 organizes and controls camera functions, such as focusing, adjusting for lighting conditions and recording pictures. In another embodiment, electronic system 20 is a PDA and operating system 36 organizes and controls functions, such as accepting calendar inputs and displaying lists. In one preferred embodiment, operating system 36 organizes execution of sparing system 38 and ECC system 40 to store data into and retrieve data from storage device 24. The operating system 36 is stored in host memory 28 as machine-readable code.

In the exemplary embodiment, host processor 26 reads operating system 36 from host memory 28 and stores selected parts of operating system 36 in RAM 34. The host processor 26 executes code directly out of host memory 28 and RAM 34. In other embodiments, host processor 26 can execute code only out of host memory 28 or host processor 26 reads all of operating system 36 from host memory 28 and stores it into RAM 34. The host processor 26 then executes solely out of RAM 34.

Sparing system 38 includes sparing table 42 and computer readable instructions to replace defective memory sections in storage device 24 with replacement memory sections in storage device 24. The sparing table 42 includes original addresses 50a-50c, that are addresses to defective memory sections in storage device 24, and spare addresses 52a-52c, that are addresses to replacement memory sections in storage device 24. Each spare address 52a-52c corresponds to an original address 50a-50c. That is, original address 50a corresponds to spare address 52a, original address 50b corresponds to spare address 52b and so on.

Host processor 26 executes sparing system 38 to compare original read addresses and original write addresses to original addresses 50 in sparing table 42. In the event of a match between an original read address or an original write address and one of the original addresses 50, host processor 26 substitutes the corresponding spare address 52 for the matching original read address or matching original write address. Host processor 26 reads data from or writes data into the substituted spare address 52, instead of the matching original read address or matching original write address.

In practice, host processor 26 receives a block of original addresses for reading data from or writing data into storage device 24. Host processor 26 executes sparing system 38 to sort through the block of original addresses and find all addresses in the block of original addresses that match original addresses 50. All matching addresses in the block of original addresses are removed and replaced with corresponding spare addresses 52. In the event no matching addresses are found in the block of original addresses, host processor 26 and storage device 24 provide a one transfer read or write operation. In the event one or more matching addresses are found in the block of original addresses, the read or write operation is divided into sub-transfers.

Each sub-transfer is a transfer of data into or out of sequential addresses in storage device 24. The address block including substituted spare addresses 52 is divided into sub-transfers of data into or out of sequential addresses around defective memory sections and including the substituted spare addresses 52. One sub-transfer includes sequential addresses leading up to a spared out defective memory section. The next sub-transfer includes the substituted spare address 52, and the next sub-transfer includes sequential addresses leading away from the spared out defective memory section, and so on until the entire address block is divided into sub-transfers. Host processor 26 processes each sub-transfer with storage device 24. The read or write operation for the entire address block is complete after all sub-transfers are complete.

Sparing table 42 is created as storage device 24 is tested. The test program reads and writes all address locations in storage device 24 to identify the number of errors in each section of memory to obtain an error count. A section of memory is classified as defective if the number of errors, i.e. the error count, for the section of memory exceeds the number of errors that can be corrected by the selected ECC scheme minus a buffer value. The address of a defective memory section is stored as an original address 50 in sparing table 42, and the address of a replacement memory section is stored as the corresponding spare address 52 in sparing table 42. The storage device 24 includes a predetermined number of replacement sections, such as 10 percent of the stated storage capacity of storage device 24.

In the exemplary embodiment, sparing table 42 is stored in host memory 28. In other embodiments, sparing table 42 can be stored in storage device 24. In addition, in other embodiments, sparing system 38 includes instructions for testing a storage device, such as storage device 24, and creating a new sparing table 42 for each new storage device 24. When sparing table 42 is stored in storage device 24 or sparing system 38 creates a new sparing table 42 for each new storage device 24, a new storage device 24 can be inserted into electronic system 20 without pre-loading a sparing table 42 into host memory 28.

In the exemplary embodiment, host processor 26 reads sparing system 38 from host memory 28 and stores selected parts of sparing system 38 in RAM 34. The host processor 26 executes code directly out of host memory 28 and RAM 34. In other embodiments, host processor 26 executes code solely out of host memory 28 or loads the entire sparing system 38 into RAM 34 and executes code solely out of RAM 34.

The ECC system 40 is a group of computer readable instructions executed by host processor 26 to provide functions including ECC encoding and ECC decoding. The ECC system 40 includes ECC encoder 44 and ECC decoder 46. Host processor 26 executes ECC encoder 44 to encode original data. The ECC encoded data is stored in storage device 24. The host processor 26 executes ECC decoder 46 to decode ECC encoded data retrieved from storage device 24. In addition, ECC system 40 includes an ECC coding table 48. The ECC coding table 48 includes addresses 54 of storage locations in storage device 24 that store ECC encoded data. The ECC system 40 is stored as machine-readable code in host memory 28.

Host processor 26 executes write instructions that include a write ECC coding flag. If the write ECC coding flag is set, host processor 26 executes ECC encoder 44 to encode the original data. In addition, address locations that store the ECC encoded data are stored in ECC coding table 48 as addresses 54. If the write ECC coding flag is not set, the original data is stored without being ECC encoded by ECC encoder 44. In another embodiment, the write instructions do not include a write ECC coding flag. Instead, all original data is ECC encoded by ECC encoder 44 and stored in storage device 24.

In the exemplary embodiment, host processor 26 reads ECC system 40 from host memory 28 and stores selected parts of ECC system 40 in RAM 34. The host processor 26 executes code directly from host memory 28 and RAM 34. In other embodiments, host processor 26 executes solely out of host memory 28 or loads the entire ECC system 40 into RAM 34 and executes code solely out of RAM 34.

In operation, host processor 26 loads part of operating system 36 into RAM 34 as electronic system 20 is booted. Host processor 26 includes boot ROM code in an on-board ROM that instructs host processor 26 to read host memory 28 and load part of operating system 36 to RAM 34. Host processor 26 begins executing operating system 36 to provide functions of electronic system 20. As host processor 26 executes operating system 36 and functions of electronic system 20, host processor 26 receives and executes read and write instructions to read data from storage device 24 and to write data into storage device 24.

During a read operation of storage device 24, host processor 26 receives a block of original read addresses to read from in storage device 24. Host processor 26 loads selected parts of sparing system 38 to RAM 34. Host processor 26 executes sparing system 38 from host memory 28 and RAM 34 to compare the block of original read addresses to original addresses 50 in sparing table 42. In the event of a match, the matching original read address is replaced with the spare address 52 corresponding to the matching original address 50. The compare operation continues until all matching original read addresses are replaced by corresponding spare addresses 52. Host processor 26 divides the read operation into sub-transfers including the inserted spare addresses 52. Host processor 26 compares the read addresses including inserted spare addresses 52 to addresses 54 in ECC coding table 48. If a match is found, a read ECC coding flag is set to indicate that the data at the matching read address is ECC encoded data.

To read storage device 24, host processor 26 sends a read command with the read ECC coding flag and a read start address to storage device 24. Storage device 24 transfers a section of data beginning at the start address to host processor 26, and asserts a signal to host processor 26 indicating the section of data has been transferred. If host processor 26 deselects storage device 24, the transfer or sub-transfer is complete. If storage device 24 remains selected by host processor 26, storage device 24 transmits the next sequentially addressed section of data to host processor 26. Sections of data are transferred until storage device 24 is deselected by host processor 26. In the event no spare address 52 is inserted in the block of original read addresses, the read operation is complete. In the event spare addresses 52 were inserted in the block of original read addresses, one sub-transfer is complete. To do another sub-transfer, host processor 26 provides another read command with the read ECC coding flag and a new start address to storage device 24. The sub-transfers continue until all of the read addresses including spare addresses 52 are read from in storage device 24.

After host processor 26 receives data from storage device 24, host processor 26 checks the read ECC coding flag to establish whether the received data is ECC encoded data. In the event the received data is not ECC encoded data, the read operation is complete. In the event the received data is ECC encoded data, host processor 26 executes ECC decoder 46 to decode the ECC encoded data. The ECC encoded data is decoded and corrected to provide data originally received for storage in storage device 24, referred to herein as original data.

During a write operation of storage device 24, host processor 26 receives or generates original data and a block of original write addresses to write to in storage device 24. Host processor 26 accesses sparing system 38 in host memory 28 and loads selected parts to RAM 34. Host processor 26 executes sparing system 38 to compare the block of original write addresses to original addresses 50 in sparing table 42. In the event one or more write addresses in the block of original write addresses matches original addresses 50, the matching original write addresses are replaced with spare addresses 52 corresponding to the matching original addresses 50. The compare operation continues until all matching original write addresses are replaced by corresponding spare addresses 52. Host processor 26 divides the write operation into sub-transfers on each side of the inserted spare addresses 52 and including the inserted spare addresses 52.

Host processor 26 ECC encodes original data according to the write ECC coding flag that is part of the write instruction executed by host processor 26. In the event the write ECC coding flag is not set, the original data is not ECC encoded and host processor 26 begins the write operation with storage device 24. In the event the write ECC coding flag is set, host processor 26 loads part of the ECC system 40, such as the ECC encoder 44, into RAM 34 and executes the ECC system 40 out of host memory 28 and RAM 34. Host processor 26 ECC encodes the original data and writes the write addresses including inserted spare addresses 52 into ECC coding table 48 as addresses 54.

To write storage device 24, host processor 26 sends a write command and a start address followed by a section of data, such as a 512 byte sector of original data or a 640 byte sector of ECC encoded data, to storage device 24. Storage device 24 asserts a busy signal to host processor 26. Storage device 24 receives the data and writes the data into sequential addresses beginning with the start address. Storage device 24 deasserts or removes the busy signal after the received data has been saved in storage device 24. If storage device 24 remains selected by host processor 26, storage device 24 increments its internal write address and host processor 26 sends more data to storage device 24. The storage device 24 receives the data and stores the data in sequential addresses. Host processor 26 deselects the storage device 24 to end a transfer or sub-transfer. In the event no spare addresses 52 were inserted in the block of original write addresses, the write operation is complete. In the event one or more spare addresses 52 were inserted in the block of original write addresses, one sub-transfer is complete. To perform another sub-transfer, host processor 26 transmits another write command, a new starting address and data to storage device 24. The sub-transfers continue until the block of write addresses including inserted spare addresses 52 are written to in storage device 24.

In another embodiment, during a write operation all original data is ECC encoded by ECC encoder 44 and stored in storage device 24. The write ECC coding flag and the ECC coding table 48 are not provided. During a read operation, all data read from storage device 24 is ECC encoded data that is decoded with ECC decoder 46. The read ECC coding flag is not provided.

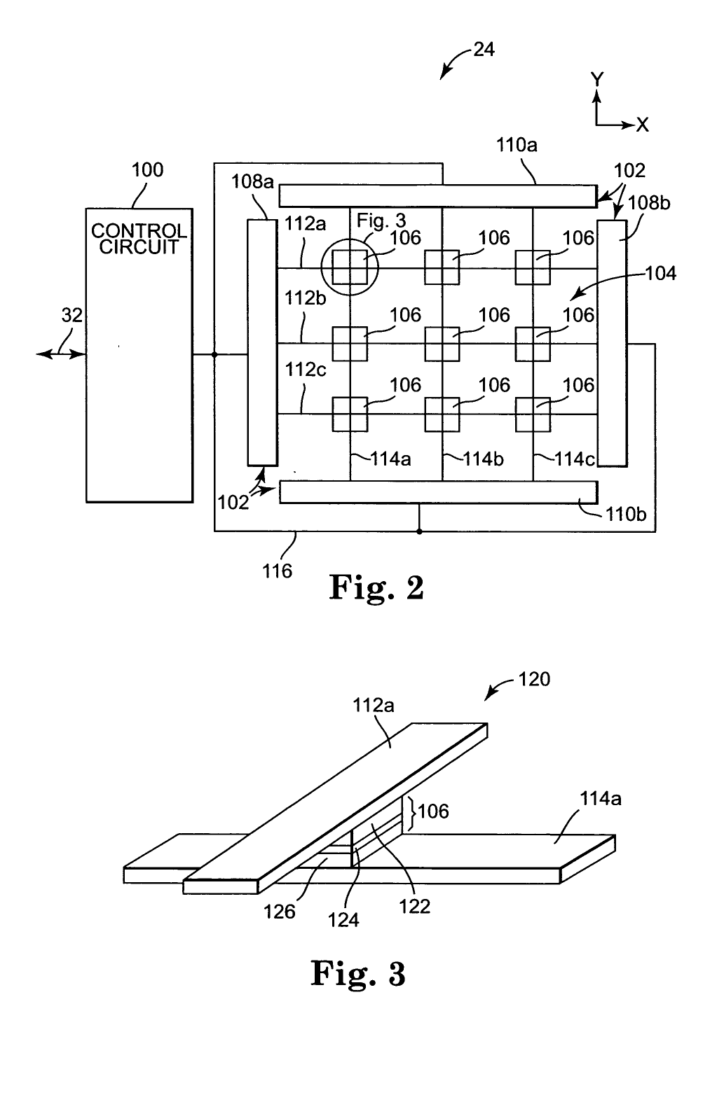

FIG. 2 is a diagram illustrating an exemplary embodiment of storage device 24. The storage device 24 includes a control circuit 100, a read/write circuit 102 and a magnetic memory cell array, indicated at 104. The memory cell array 104 includes magnetic memory cells 106. In other embodiments, the storage device can use other suitable memory types, such as PCRAM or probe-based memories. In probe-based memories, arrays of mechanical probes interact with portions of the memory medium to read data from and write data into the memory medium. Methods for storing data in probe-based memory include charge storage, magnetic, thermo-mechanical and phase change methods.

In the exemplary embodiment, magnetic memory cells 106 are arranged in rows and columns, with the rows extending along an x-direction and the columns extending along a y-direction. Only a relatively small number of memory cells 106 are shown to simplify the illustration of storage device 24. In practice, arrays of any suitable size can be used and the arrays can be stacked to form three-dimensional macro-array structures that operate in highly parallel modes, such as the macro-array described later herein.

The read/write circuit 102 includes read/write row circuits 108a and 108b, and read/write column circuits 110a and 110b. The row circuits 108a and 108b are electrically coupled to word lines 112a-112c and the column circuits 110a and 110b are electrically coupled to bit lines 114a-114c. The conductive word lines 112a-112c extend along the x-direction in a plane on one side of array 104. The conductive bit lines 114a-114c extend along the y-direction in a plane on an opposing side of array 104. There is one word line 112a-112c for each row of array 104, and one bit line 114a-114c for each column of array 104. A memory cell 106 is located at each cross-point of a word line 112a-112c and a bit line 114a-114c.

The control circuit 100 is electrically coupled to row circuits 108a and 108b and column circuits 110a and 110b through conductive read/write paths, indicated at 116. In addition, control circuit 100 is electrically coupled to host processor 26 through conductive I/O paths 32. Control circuit 100 includes circuits for communicating with host processor 26 and read/write circuit 102. Control circuit 100, read/write circuit 102 and array 104 can be formed on a single substrate or arranged on separate substrates. In the exemplary embodiment, control circuit 100, read/write circuit 102 and array 104 are formed on the same substrate.

Control circuit 100 manages read and write operations between storage device 24 and host processor 26. In addition, control circuit 100 controls read/write circuit 102 to write data into array 104 and read data from array 104. Control circuit 100 receives write commands, and write addresses and data from host processor 26 through I/O paths 32. Control circuit 100 receives read commands and read addresses from host processor 26 and transmits data to host processor 26 through I/O paths 32.

To manage a read operation, control circuit 100 provides the signal indicating a section of data has been transferred to host processor 26 and checks to see if storage device 24 remains selected by host processor 26. In the event storage device 24 remains selected, control circuit 100 increments an internal read address and transmits more data to host processor 26. In the event storage device 24 is deselected, control circuit 100 terminates the read operation.

To manage a write operation, control circuit 100 asserts the busy signal to host processor 26 while writing array 104 and deasserts the busy signal after array 104 is written. In addition, control circuit 100 checks to see whether storage device 24 remains selected by host processor 26. In the event storage device 24 remains selected, control circuit 100 increments an internal write address and receives more data from host processor 26. In the event storage device 24 is deselected, control circuit 100 terminates the write operation.

The read/write circuit 102 provides write currents through word lines 112a-112c and bit lines 114a-114c to write memory cells 106 in array 104. To write a selected memory cell 106, row circuits 108a and 108b provide a first write current through a selected word line 112a-112c, and column circuits 110a and 110b provide a second write current through a selected bit line 114a-114c. The row circuits 108a and 108b can provide the first write current through the selected word line 112a-112c in either direction as needed for writing the selected memory cell 106. The column circuits 110a and 110b can provide the second write current through the selected bit line 114a-114c in either direction as needed to write the selected memory cell 106. The first write current flows from/to row circuit 108a and through the selected word line 112a-112c to/from row circuit 108b. The second write current flows from/to column circuit 110a and through the selected bit line 114a-114c to/from column circuit 110b. One read/write circuit 102 is illustrated as coupled to array 104. In practice, any suitable number of read/write circuits can be coupled to array 104 and array 104 can include any suitable number of memory cells 106. The memory cells 106 in array 104 can be written to and read from in highly parallel modes.

Row circuits 108a and 108b select one word line 112a-112c and column circuits 110a and 110b select one bit line 114a-114c to set or switch the orientation of magnetization in the sense layer of the memory cell 106 located at the cross-point of the selected word line 112a-112c and bit line 114a-114c. Row circuits 108a and 108b provide the first write current to the selected word line 112a-112c and column circuits 110a and 110b provide the second write current to the selected bit line 114a-114c. The first write current creates a magnetic field around the selected word line 112a-112c, according to the right hand rule, and the second write current creates a magnetic field around the selected bit line 114a-114c, according to the right hand rule. The magnetic fields combine to set or switch the orientation of magnetization in the sense layer of the selected memory cell 106.

To read data from array 104, read/write circuit 102 selects one word line 112a-112c and one bit line 114a-114c to sense the resistance through the memory cell 106 located at the cross-point of the selected word line 112a-112c and bit line 114a-114c. The row circuit 108a selects a word line 112a-112c, and the column circuit 110a selects a bit line 114a-114c. The row circuit 108a electrically couples the selected word line 112a-112c to ground. The column circuit 110a provides a constant sense voltage on the selected bit line 114a-114c to produce a sense current through the selected memory cell 106. The magnitude of the sense current through the selected memory cell 106 corresponds to the resistive state and the logic state of the selected memory cell 106. The column circuit 110a senses the magnitude of the sense current and provides a logic output signal to control circuit 100. The logic output signal is a high or low logic level indicating the resistive state of the selected memory cell 106.

During a write operation, control circuit 100 receives a write command, starting write address and data from host processor 26. Control circuit 100 asserts the busy signal to host processor 26 and provides a predetermined number of sequential write addresses and the received data to read/write circuit 102. The read/write circuit 102 writes the data into array 104. After the data is written to array 104, control circuit 100 deasserts the busy signal to host processor 26 and checks to see whether storage device 24 remains selected by host processor 26. In the event storage device 24 remains selected, control circuit 100 increments the internal write address and receives more data from host processor 26. Control circuit 100 asserts the busy signal and passes write addresses and the received data to read/write circuit 102 to continue the data transfer. The data transfer is complete if storage device 24 does not remain selected or is deselected by host processor 26.

During a read operation, control circuit 100 receives a read command and a starting address from host processor 26. Control circuit 100 provides a predetermined number of sequential read addresses to read/write circuit 102. The read/write circuit 102, reads data from array 104 at the provided read addresses and passes the data to control circuit 100. Control circuit 100 transmits the data to host processor 26. After the data is transmitted to host processor 26, control circuit 100 asserts the signal indicating the data is transferred to host processor 26. Control circuit 100 checks to see whether storage device remains selected by host processor 26. In the event storage device 24 remains selected, control circuit 100 increments the internal read address and provides another set of data to host processor 26. The data transfer or sub-transfer is complete if storage device 24 is deselected by host processor 26.

FIG. 3 is a diagram illustrating an exemplary embodiment of an array section, indicated at 120. Array section 120 includes a word line 112a, memory cell 106 and a bit line 114a. Memory cell 106 is located between word line 112a and bit line 114a. In the exemplary embodiment, word line 112a and bit line 114a are orthogonal to one another. In other embodiments, word line 112a and bit line 114a can lie in other suitable angular relationships with one another.

Memory cell 106 includes a sense layer 122, a spacer layer 124 and a reference layer 126. The spacer layer 124 is located between sense layer 122 and reference layer 126. Sense layer 122 is located between spacer layer 124 and word line 112a. Reference layer 126 is located between spacer layer 124 and bit line 114a.

Sense layer 122 has an alterable orientation of magnetization and reference layer 126 has a pinned orientation of magnetization. In the exemplary embodiment, memory cell 106 is an MTJ spin-tunneling device with spacer layer 124 being an insulating barrier layer through which an electrical charge tunnels during read operations. Electrical charge tunneling through spacer layer 124 occurs in response to a sense voltage across memory cell 106. In another embodiment, a GMR structure can be used for memory cell 106, with spacer layer 124 being a conductor, such as copper.

In the exemplary embodiment, word line 112a and bit line 114a are electrically coupled to read/write circuit 102. The word line 112a is electrically coupled to row circuits 108a and 108b, and bit line 114a is electrically coupled to column circuits 110a and 110b. To write memory cell 106, row circuits 108a and 108b provide the first write current to word line 112a and column circuits 110a and 110b provide the second write current to bit line 114a. The first write current through word line 112a creates a magnetic field, according to the right hand rule, around word line 112a and in memory cell 106. The second write current through bit line 114a creates a magnetic field, according to the right hand rule, around bit line 114a and in memory cell 106. The magnetic fields combine to set or switch the state of memory cell 106.

To read the resistive state and logic state of memory cell 106, row circuit 108a electrically couples word line 112a to ground, and column circuit 110a provides a constant sense voltage on bit line 114a. Bit lines 114b and 114c are held at the same voltage or reference potential as bit line 114a. Also, word lines 112b and 112c are held at the same reference potential as bit line 114a. The equal potentials across bit lines 114a-114c and word lines 112b-112c stop “sneak” currents from flowing through unselected memory cells 106. The constant sense voltage on bit line 114a and across the selected memory cell 106 produces a sense current through memory cell 106 from bit line 114a to word line 112a and ground. The magnitude of the sense current indicates the resistive state of memory cell 106. Column circuit 110a senses the magnitude of the sense current and provides an output signal indicative of the resistive state and logic state of memory cell 106 to control circuit 100.

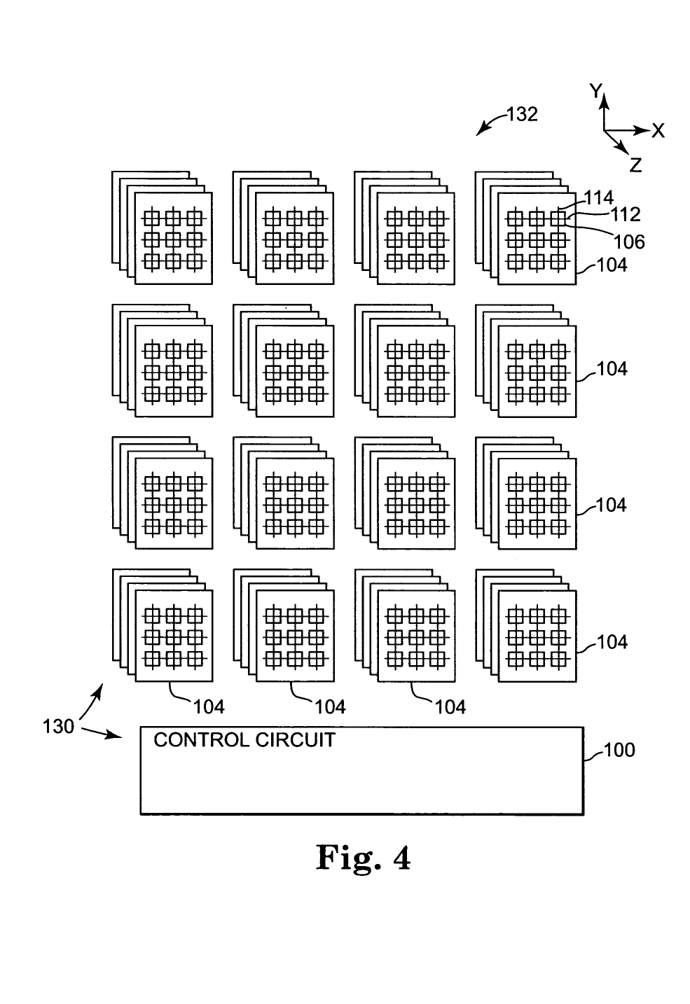

FIG. 4 is a diagram illustrating another magnetic memory storage device 130. Storage device 130 includes a macro-array 132 and control circuit 100. The macro-array 132 includes a plurality of magnetic memory cell arrays 104. Each memory cell array 104 includes memory cells 106 that are intersected by word lines 112 and bit lines 114. The arrays 104 are formed and electrically coupled to control circuit 100 as previously described. Using multiple, individual arrays 104 in a macro-array, such as macro-array 132, makes it possible to have a macro-array with a large overall data storage capacity, without the individually arrays 104 becoming so large that they are difficult to manufacture and control.

The arrays 104 are arranged in rows and columns, with the rows extending along the x-direction and the columns extending along the y-direction. In addition, the arrays 104 are arranged in stacks that extend along the z-direction. Only a relatively small number of memory cells 106 and arrays 104 are shown to simplify the illustration. In practice, arrays of any suitable size and macro-arrays of any suitable size can be used.

In one suitable 128 M byte macro-array, 1,024 arrays are arranged in a macro-array that is 16 arrays high, by 16 arrays wide, with four stack layers. Each individual array is a 1 M bit array that is 1,024 memory cells high, by 1,024 memory cells wide. Optionally, the magnetic memory comprises more than one such macro-array.

In one suitable addressing scheme for the 128 M byte array, memory cells are accessed by selecting one word line in each of a plurality of arrays and by selecting multiple bit lines in each of the plurality of arrays. Selecting multiple bit lines in each array, selects multiple memory cells from each array. The accessed memory cells within each of the plurality of arrays correspond to a small portion of a unit of data. Together, the accessed memory cells provide a whole unit of data, such as a sector of 512 bytes, or a substantial portion of a whole unit of data. The memory cells are accessed substantially simultaneously.

In storage device 130, memory cells 106 are accessed by selecting one word line 112 and multiple bit lines 114 in each of a plurality of arrays 104 to thereby select a plurality of memory cells 106. The accessed memory cells 106 correspond to at least a portion of a whole section of data, such as a sector of 512 bytes. The plurality of arrays 104 can be accessed substantially simultaneously. In other embodiments and in practice, other suitable accessing schemes can be used, such as selecting one bit line 114 and multiple word lines 112 in each of a plurality of arrays 104.

Although arrays 104 and 132 are generally reliable, failures can occur that affect the ability of memory cells 106 to store data. The failures can be systematic failures or random failures. Systematic failures consistently affect a particular memory cell 106 or a particular group of memory cells 106. Random failures occur transiently and are not consistently repeatable. Systematic failures usually arise as a result of manufacturing imperfections and aging. Random failures occur in response to internal and external environmental effects, such as noise during a read or write process, temperature and surrounding electromagnetic noise. A memory cell 106 affected by a failure can become unreadable such that no logical value can be read from memory cell 106 or the logical value read from memory cell 106 is not necessarily the same as the logical value written to memory cell 106.

Failure mechanisms take many forms including shorted bits, open bits, half-select bits and single failed bits. In shorted bits, the resistance through the memory cell 106 is much lower than expected. Shorted bits tend to affect all memory cells 106 lying in the same row and the same column. In open bits, the resistance through the memory cell 106 is much higher than expected. Open bit failures can, but do not always, affect all memory cells 106 lying in the same row or column, or both. Half-select bit failures occur when writing a memory cell 106 in a particular row or column causes another memory cell 106 in the same row or column to change state. A memory cell 106 that is vulnerable to a half-select failure will therefore possibly change state in response to writing any memory cell 106 in the same row or column, resulting in unreliable stored data. A single failed bit is where a particular memory cell 106 is fixed in a high resistive or a low resistive state. A single failed bit does not necessarily affect other memory cells 106 and is not affected by activity in other memory cells 106. These four failure mechanisms are systematic failures, in that the same memory cell(s) 106 are consistently affected. Where the failure mechanism affects only one memory cell 106, it is referred to as an isolated failure. Where the failure mechanism affects a group of memory cells 106, it is referred to as a grouped failure.

While memory cells 106 can be used to store data according to any suitable logical layout, data is preferably organized into basic sub-units, such as bytes. In turn, the basic sub-units are grouped into larger logical data units, such as sectors of 512 bytes or 640 bytes. A physical failure, and in particular a grouped failure affecting many memory cells 106 can affect many bytes and many sectors, such that avoiding the use of all bytes, sectors, or other units affected by the failure substantially reduces the storage capacity of the storage device. For example, a grouped failure such as a shorted bit failure in just one memory cell 106 can affect many other memory cells 106 that lie in the same row or the same column. In a 1 M bit array that is 1,024 memory cells 106 by 1,024 memory cells 106, a single shorted bit failure in one memory cell 106 can affect over 1000 other memory cells 106 lying in the same row, and over 1000 memory cells 106 lying in the same column. The affected memory cells 106 may be part of many bytes and many sectors, and not using the affected bytes and sectors reduces the storage capacity of the magnetic memory.

In the exemplary embodiment, data can be encoded with an ECC scheme and stored as ECC encoded data in arrays 104 and 132. Error correction coding involves receiving original data for storage and forming ECC encoded data that allows errors to be identified and ideally corrected. The ECC encoded data includes the original data and ECC parity data. The ECC encoded data is stored in arrays 104 and 132.

During a read operation, the ECC encoded data is decoded to recover the original data. ECC decoder 46 uses the ECC parity data to decode and correct corrupted ECC encoded data to recover the original data. A wide range of ECC schemes are available and can be employed alone or in combination. Suitable ECC schemes include schemes with single-bit symbols, such as Bose Chaudhufi Hocquenghem (BCH), and schemes with multiple-bit symbols, such as Reed-Solomon codes. The ECC schemes can correct a given number of errors in a section of memory. If the number of errors in a section of memory exceeds the number of errors a particular ECC scheme can correct, data stored into and retrieved from the section is not reliable even with ECC encoding and decoding of the data.

In the exemplary embodiment, sections of memory that have a larger number of errors, i.e. a larger error count, than a predetermined error threshold value are not used. Instead, the sections of memory are referred to as defective sections of memory and the addresses of the defective sections of memory are replaced with the addresses of replacement sections of memory during read and write operations. The defective sections of memory are spared out and replaced with replacement sections of memory.

The arrays 104 and 132 are built to include a predetermined number of replacement sections of memory. The replacement sections of memory are in addition to the stated size of storage devices 24 and 130. In the exemplary embodiment, the number of memory cells 106 in replacement sections of memory is equal to 10 percent of the stated size of storage devices 24 and 130. For example, a 128 M byte array includes an additional 12.8 M bytes of memory cells 106 in replacement sections. In other embodiments, any suitable number of memory cells 106 in replacement sections of memory can be included in the storage device, such as 5 percent or 15 percent of the stated size of the storage device.

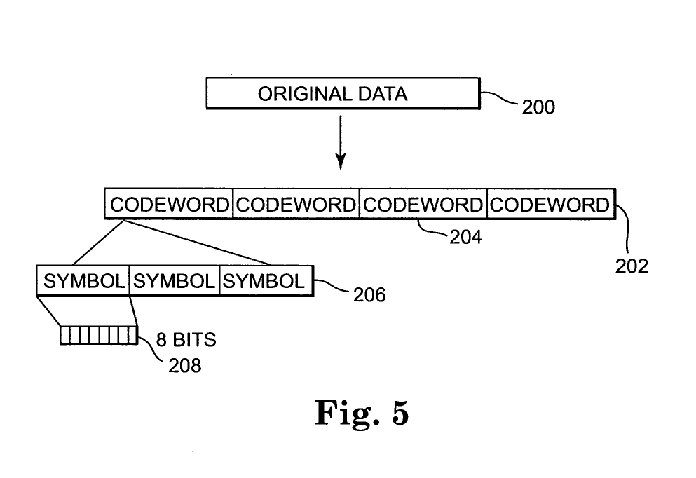

FIG. 5 is a diagram illustrating an exemplary logical data structure for ECC encoded data stored in arrays 104 and 132 using a Reed-Solomon ECC scheme. Original data is received by host processor 26 in an original data sector comprising 512 bytes of data, indicated at 200. Host processor 26 executes ECC encoder 44 to encode the received original data sector 200 and provide the ECC encoded data sector, indicated at 202. The ECC encoded data sector 202 comprises four codewords 204. Each codeword 204 comprises 160 symbols 206, and each symbol 206 comprises eight bits, indicated at 208. In other embodiments, each symbol 206 can be a single bit (e.g. a BCH code with single-bit symbols) or multiple bits other than eight bits, such as 10 bits (e.g. in a Reed-Solomon code using multiple-bit symbols). The eight bits 208 correspond to a symbol 206 and are stored in eight memory cells 106, termed a symbol group. A physical failure that directly or indirectly affects any of the eight memory cells 106 in a symbol group can result in one or more of the bits being unreadable and giving a failed symbol 206.

Each block of stored ECC encoded data is read from memory cells 106 and received by host processor 26. The host processor 26 executes ECC decoder 46 to decode the ECC encoded data and identify and correct failed symbols 206. Decoding is performed independently for each block of ECC encoded data, such as ECC encoded data sector 202 or ECC codeword 204.

In the exemplary embodiment, host processor 26 and ECC system 40 provide a Reed-Solomon ECC scheme to encode received original data 200 and decode the ECC encoded data sector 202. The Reed-Solomon ECC scheme is a linear error correcting code that mathematically identifies and corrects up to a predetermined maximum number of failed symbols 206 within each block of ECC encoded data. For example, a [160, 128, 32] Reed-Solomon code producing codewords of 160 eight-bit symbols corresponding to 128 original data bytes can locate and correct up to 16 random errors in 160 bytes. In another example, a [132, 128, 4] Reed-Solomon code producing codewords of 132 eight-bit symbols corresponding to 128 original data bytes can locate and correct up to two random errors in 132 bytes.

In the exemplary embodiment, ECC system 40 provides a [160, 128, 32] Reed-Solomon code for encoding original data 200 and decoding ECC encoded data 202. The ECC encoded data 202 is divided into four codewords 204. Each codeword 204 includes 128 bytes of original data and 32 bytes of ECC parity data resulting in a codeword length of 160 bytes and an ECC encoded data sector 202 length of 640 bytes. In other embodiments, ECC system 40 can provide any suitable ECC scheme, such as a [132, 128, 4] Reed-Solomon code.

The ECC system 40 includes instructions to identify sections of memory in arrays 104 and 132 that are growing errors or failed memory cells 106 such that the identified sections of memory are becoming unusable. The ECC system 40 includes an error threshold limit based on the provided ECC scheme. As the number of errors identified in a section of memory exceeds the error threshold limit, the ECC system 40 identifies the memory section as a defective memory section. The ECC system 40 and sparing system 38 include instructions that assign an address of a replacement memory section to the address of the defective memory section. The address of the defective memory section is stored as the original address 50 and the address of the corresponding replacement section is stored as the spare address 52 in sparing table 42.

In the exemplary embodiment, ECC system 40 provides the [160, 128, 32] Reed-Solomon ECC scheme. The [160, 128, 32] Reed-Solomon ECC scheme can correct up to 16 random errors in 160 bytes of encoded data. The 160 bytes of encoded data represent 128 bytes of original data. The error threshold limit value for 160 bytes of encoded data is set to 13 errors or about 80 percent of the number of errors the provided [160, 128, 32] Reed-Solomon ECC scheme can correct. Setting the error threshold limit to 80 percent of the power of the ECC scheme gives an error margin that ensures little or no original data is lost. In other embodiments, the error threshold limit value can be set to any suitable value, such as between 50 percent and 90 percent of the power of the ECC scheme, to ensure adequate correction of corrupted data without losing original data.

The error threshold limit is also used to initially build sparing table 42. The storage devices 24 and 130 are tested by test equipment executing a test program. The test program uses the error threshold limit to identify defective sections of memory. The test program identifies defective memory sections and assigns corresponding replacement memory sections. The addresses of the defective memory sections are stored as original addresses 50 and the addresses of the corresponding replacement sections are stored as spare addresses 52 in sparing table 42. The ECC system 40 updates sparing table 42 to include the addresses of new or grown defective sections of memory and the corresponding replacement sections of memory.

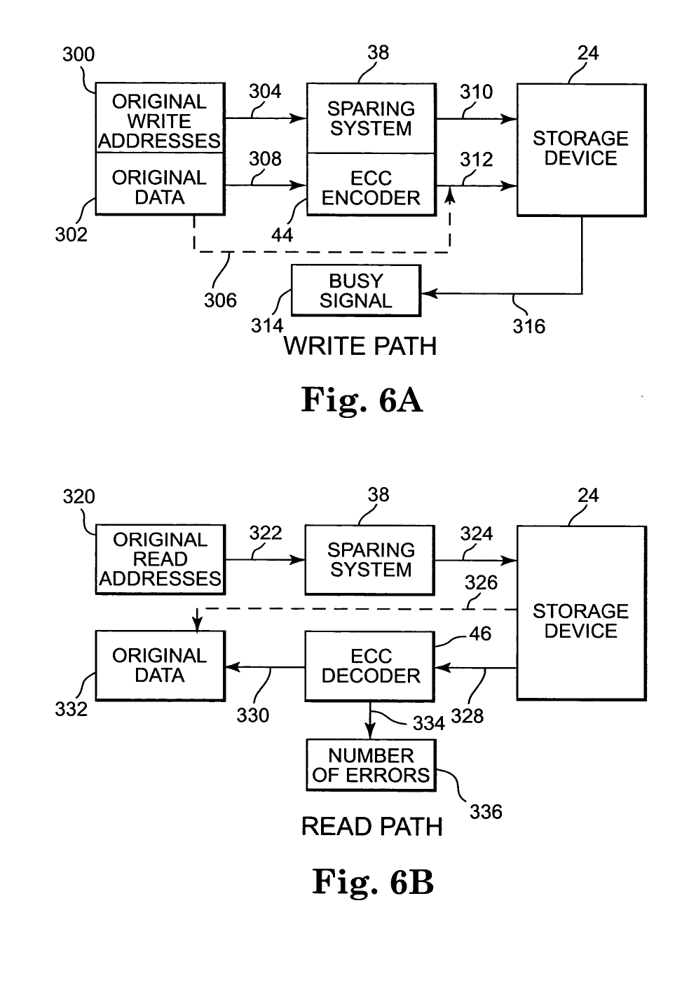

FIGS. 6A and 6B are diagrams illustrating different aspects of an exemplary embodiment of sparing system 38 and ECC system 40. FIG. 6A illustrates a write path of the exemplary embodiment for storing data in storage device 24. FIG. 6B illustrates a read path of the exemplary embodiment for reading data from storage device 24. The write path and read path are provided by host processor 26 executing operating system 36, sparing system 38 and ECC system 40. In other embodiments, storage device 24 is replaced by storage device 130, and the write path and read path are provided by host processor 26 executing operating system 36, sparing system 38 and ECC system 40 to read data from and write data into storage device 130.

FIG. 6A is a diagram illustrating a write path of the exemplary embodiment for storing data in storage device 24. The write path includes original write addresses 300 and original data 302 received by host processor 26 in a write instruction. The original write addresses 300 are sequential address locations in storage device 24 where the original data is to be stored, unless the original write addresses point to defective sections of memory in storage device 24.

The host processor 26 executes operating system 36 that includes a sequence for executing sparing system 38 and ECC system 40 including ECC encoder 44. In the exemplary embodiment, the sparing system 38 is executed before the ECC system 40 to write data into storage device 24. In other embodiments, the ECC system 40 can be executed before sparing system 38 or sparing system 38 and ECC system 40 can be executed in parallel to write data into storage device 24. The original write addresses 300 are passed at 304 to sparing system 38.

The sparing system 38 is executed by host processor 26 to replace original write addresses 300 pointing to defective sections of memory in storage device 24 with addresses of replacement memory sections. The original write addresses 300 are compared to original addresses 50 in sparing table 42. In the event of a match, the address of the matching original write address 300 is replaced by the corresponding spare address 52 from sparing table 42. Each original write address 300 is compared to the original addresses 50 in sparing table 42, and replaced by the corresponding spare address 52 if a match is found in sparing table 42. Host processor 26 executes sparing system 38 to compile a list of write addresses including substitute spare addresses 52 that are written to in storage device 24. The list of write addresses is divided into sub-transfers of sequential address locations in storage device 24.

The write instruction executed by host processor 26 includes the write ECC coding flag. The write ECC coding flag indicates whether the original data 302 is to be ECC encoded. In the event the write ECC coding flag is cleared, the original data 302 are not ECC encoded, indicated at 306. In the event the write ECC coding flag is set, the original data 302 are passed at 308 to ECC system 40 and ECC encoder 44.

The ECC system 40, including ECC encoder 44, is executed by host processor 26 to ECC encode the original data 302. The ECC encoding table 48 is updated with the list of write addresses including substitute spare addresses 52 to indicate that data stored in the write addresses is ECC encoded data. The host processor 26 executes ECC encoder 44 to ECC encode the original data 302 with the [160, 128, 32] Reed-Solomon ECC scheme. The ECC encoded data is temporarily stored in RAM 34.

Host processor 26 selects storage device 24 and transfers a write command and a write start address, indicated at 310, to storage device 24. The write start address is the first address in a transfer or sub-transfer of data to sequential address locations in storage device 24. Host processor 26 transfers a section of data, such as a 512-byte original data sector 200 or a 640 byte ECC encoded data sector 202 to storage device 24 at 312. Storage device 24 asserts a busy signal 314, indicated at 316, and writes the section of data to sequential addresses in storage device 24. After storage device 24 has written the data to memory cells 106, the storage device 24 deasserts busy signal 314. If host processor 26 continues to select storage device 24, the storage device 24 increments an internal write address and receives another section of data from host processor 26. Storage device 24 asserts the busy signal 314 and writes the received section of data into sequential address locations. Host processor 26 deselects storage device 24 to end the transfer or sub-transfer. In the event the write operation includes multiple sub-transfers, host processor 26 sends another write command, a new write start address and data for the next sub-transfer. The next sub-transfer is executed similar to the previous sub-transfer and the process continues until all sub-transfers for the list of write addresses including substitute spare addresses 52 are complete.

FIG. 6B is a diagram illustrating a read path of the exemplary embodiment for retrieving data from storage device 24. The read path includes original read addresses 320 received by host processor 26 in a read instruction. The original read addresses 320 point to address locations in storage device 24 that hold data to be retrieved from storage device 24, except for original read addresses 320 that point to spared out defective sections of memory in storage device 24. The original read addresses 320 are passed at 322 to sparing system 38.

The sparing system 38 is executed by host processor 26 to replace original read addresses 320 pointing to defective sections of memory in storage device 24 with corresponding spare addresses 52 from sparing table 42. The original read addresses 320 are compared to original addresses 50 in sparing table 42. In the event of a match, the matching original read address is replaced with the corresponding replacement or spare address 52. Each original read address 320 is compared to original addresses 50 in sparing table 42, and replaced with a spare address 52 if a match is found in sparing table 42. Host processor 26 executes sparing system 38 to compile a list of read addresses including substitute spare addresses 52. The list of read addresses including substitute spare addresses 52 is divided into sub-transfers of sequential address locations.

The list of read addresses is compared to addresses 54 in ECC coding table 48. In the event of a match, a read ECC coding flag is set to indicate that the data stored at the matching read address stores ECC encoded data. The ECC encoded data is stored in 640 byte ECC encoded data sectors 202, and original data is stored in 512 byte original data sectors 200.

Host processor 26 selects storage device 24 and transfers at 324 a read command with the read ECC coding flag and a read start address to storage device 24. The read start address is the first address in a transfer or sub-transfer of data from sequential address locations in storage device 24. In the event the read ECC coding flag is cleared, storage device 24 transfers a 512 byte original data sector 200 at 326 to host processor 26. In the event the read ECC coding flag is set, storage device 24 transfers a 640 byte ECC encoded data sector 202 at 328 to host processor 26. The storage device 24 transfers a section of data beginning at the read start address to host processor 26 and asserts a signal to host processor 26 to indicate the section of data has been transferred. In the event host processor 26 continues to select storage device 24, the storage device 24 increments an internal read address and transmits the next sequentially addressed section of data. The data transfers continue until host processor 26 deselects storage device 24. Deselecting storage device 24 ends a transfer or sub-transfer. In the event the read operation includes multiple sub-transfers, host processor 26 transfers another read command with the read ECC coding flag and another read start address to storage device 24. The sub-transfers continue until all sub-transfers for the list of read addresses including substitute spare addresses 52 are complete.

Host processor 26 receives data from storage device 24 and checks the read ECC coding flag. In the event the read ECC coding flag is cleared, the original data bypasses ECC decoder 46 at 326 to provide original data 332, and the read operation is complete. In the event the read ECC coding flag is set, the ECC encoded data is transferred at 328 to ECC decoder 46. The ECC encoded data is decoded with the [160, 128, 32] Reed-Solomon ECC scheme and passed at 330 to provide original data 332.

The ECC system 40 is used to decode ECC encoded data, count the number of errors to obtain an error count and store at 334 the number of errors 336 encountered for each 160 byte section of ECC encoded data. The number of errors 336 for each section of decoded data is compared to the error threshold value of 13. If the error count exceeds the error threshold value, the 640 byte sector that stored the 160 bytes of ECC encoded data is identified as a defective sector. The address of the defective sector along with a corresponding spare address that points to a replacement memory section is entered into sparing table 42, and the read operation is complete.

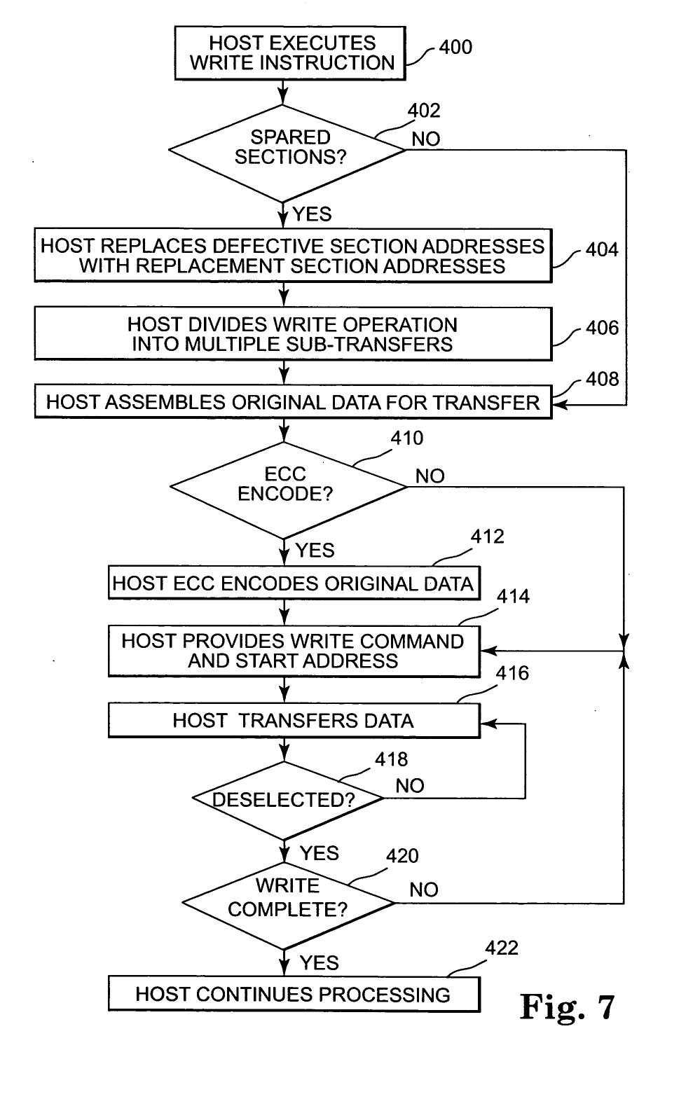

FIG. 7 is a flow chart illustrating a write operation. At 400, host processor 26 executes a write instruction while executing the operating system 36 and providing functions of host computer 22. The write instruction includes original write addresses 300 and original data 302. At 402, host processor 26 executes sparing system 38 and compares the original write addresses 300 to original addresses 50 from sparing table 42.

At 404, in the event of a match between an original write address 300 and an original address 50, the matching original write address 300 is replaced with the corresponding spare address 52 from sparing table 42. That is, host processor 26 executes sparing system 38 to replace matching defective memory section addresses with the corresponding replacement memory section addresses. At 406, host processor 26 divides the write operation into multiple sub-transfers including substituted spare addresses 52. At 408, host processor 26 executes ECC system 40 to assemble data for transferring the data to storage device 24. In the event the original write addresses 300 do not match any original addresses 50 in sparing table 42, at 402, host processor 26 does not divide the write operation into multiple sub-transfers. Instead, the write operation is one transfer of data and host processor executes ECC system 40 at 408 to assemble data for transferring the data to storage device 24.

At 410, host processor 26 checks the write ECC coding flag. In the event the write ECC coding flag is set, host processor 26 executes ECC system 40 and ECC encoder 44, at 412, to ECC encode the original data 302.

At 414, host processor 26 provides a write command and a write start address to storage device 24. In the event the write ECC coding flag is clear, ECC encoding at 412 is skipped and host processor 26 provides a write command and write start address to storage device 24 at 414. The write command instructs the storage device 24 to execute a sequential address write operation beginning with the provided write start address.

At 416, host processor 26 transfers data to storage device 24. The data is either ECC encoded data or original data. Storage device 24 receives the data, asserts a busy signal and writes the data into sequential write addresses in storage device 24. After the data is written, storage device 24 deasserts the busy signal.

At 418, storage device 24 checks whether host processor 26 has deselected the storage device 24. In the event the storage device 24 remains selected, host processor 26 transfers more data at 416, such as a 512 byte original data sector 200 or a 640 byte ECC encoded data sector 202, to storage device 24. The storage device 24 asserts the busy signal and increments write addresses to store the data. After the data is written into storage device 24, the storage device deasserts the busy signal.

In the event storage device 24 is deselected, host processor 26 checks whether the write operation is complete at 420. If host processor 26 has not completed all sub-transfers from the list of write addresses including substitute spare addresses 52, host processor 26 provides another write command and a new write start address to storage device 24 at 414 to continue the write operation. In the event of a single transfer with no spare addresses 52 or in the event all sub-transfers are complete at 420, the write operation is complete and host processor 26 continues processing at 422.

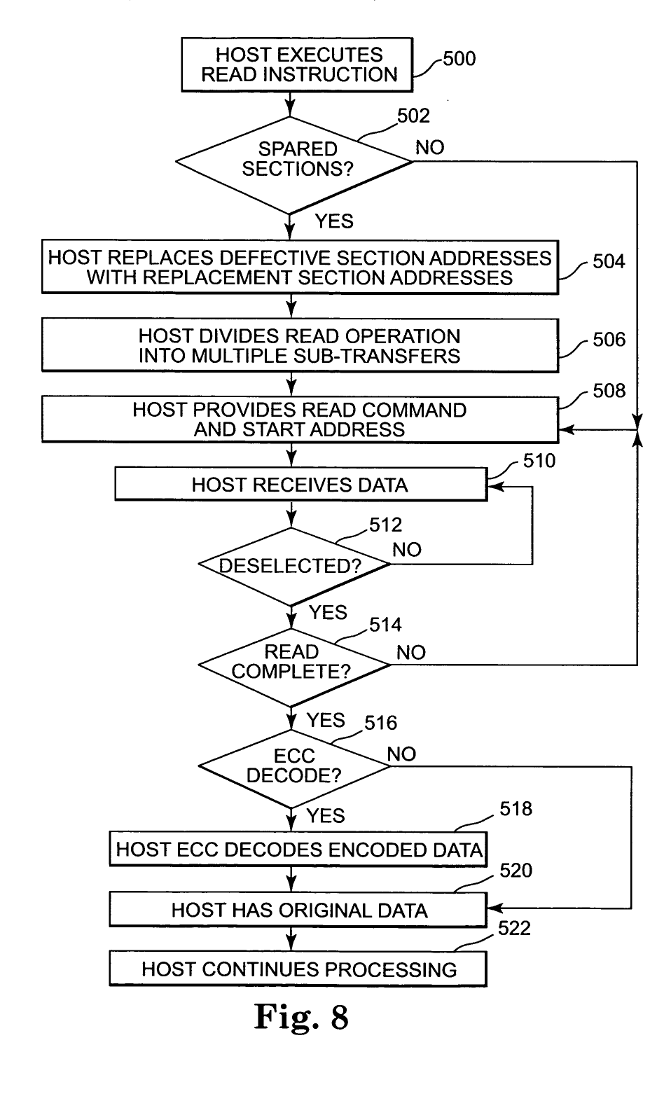

FIG. 8 is a flow chart illustrating a read operation. At 500, host processor 26 executes a read instruction while executing the operating system 36 and providing functions of host computer 22. The read instruction includes original read addresses 320. At 502, host processor 26 executes sparing system 38 and compares the original read addresses 320 from the read instruction to original addresses 50 from sparing table 42.

At 504, in the event of one or more matches between original read addresses 320 and original addresses 50, the matching original read addresses 320 are replaced with the corresponding spare addresses 52 from sparing table 42. That is, host processor 26 executes sparing system 38 to replace matching defective memory section addresses with the corresponding replacement memory section addresses. At 506, host processor 26 divides the read operation into multiple sub-transfers including any substitute spare addresses 52. Host processor 26 provides a read command with the read ECC coding flag and a read start address to storage device 24 at 508. In the event the original read addresses 320 do not match any original addresses 50 in sparing table 42 at 502, host processor 26 does not divide the read operation into multiple sub-transfers. Instead, the read operation is a single transfer and host processor 26 provides a read command with the read ECC coding flag and a read start address to storage device 24 at 508. The read command with the read ECC coding flag instructs storage device 24 to execute a sequential address read operation beginning with the provided start address.

The read ECC coding flag is set or cleared based on a comparison between the list of read addresses including any substitute spare addresses 52 and the addresses 54 in ECC coding table 48. If the read ECC coding flag is set, a 640 byte ECC encoded data sector 202 is read from storage device 24, and if the read ECC coding flag is cleared, a 512 byte original data sector 200 is read from storage device 24. At 510, host processor 26 receives the data from storage device 24 and storage device 24 signals host processor 26 to indicate that the data has been transferred.

At 512, storage device 24 checks whether host processor 26 has deselected storage device 24. In the event the storage device 24 remains selected, storage device 24 increments its internal read address and transfers another section of data to host processor 26 at 510. In the event the storage device 24 is deselected, host processor 26 checks to see whether all transfers or sub-transfers are complete at 514. If host processor 26 has not completed all sub-transfers, host processor 26 provides another read command with the read ECC coding flag and a new read start address to storage device 24 at 508 to continue the read operation. In the event a single transfer is complete or all sub-transfers are complete at 514, host processor 26 continues by executing ECC system 40.

At 516, host processor 26 checks the read ECC coding flag. If the read ECC coding flag is set, host processor 26 executes ECC decoder 46 at 518 to decode and correct the received data. The number of errors encountered is stored and compared to the error threshold value to identify grown defective memory sections. Host processor 26 is left with original data at 520 and processing continues at 522. In the event the read ECC coding flag is cleared at 516, host processor 26 has the original data at 520 and processing continues at 522.

1. A data storage and retrieval system operating on a host computer, the data storage and retrieval system comprising:
a sparing system configured to replace defective memory sections of a memory device with replacement memory sections of the memory device; and
an error correction code system configured to encode data with an error correction code, store the data into the memory device, and decode the encoded data with the error correction code to retrieve the data from the memory device.

2. The data storage and retrieval system of claim 1, where the sparing system comprises a sparing table stored on the host computer.

3. The data storage and retrieval system of claim 1, where the sparing system comprises a sparing table stored in the memory device.

4. The data storage and retrieval system of claim 1, where the sparing system comprises a sparing table comprising entries obtained from a tester that tests the memory device.

5. The data storage and retrieval system of claim 1, where the sparing system comprises a sparing table comprising entries obtained from the sparing system that is configured to test the memory device to obtain the entries for the sparing table.

6. The data storage and retrieval system of claim 1, where the sparing system comprises a sparing table, and the sparing system and the error correction code system are configured to update the sparing table as defective memory sections are detected in the memory device.

7. The data storage and retrieval system of claim 1, where the sparing system comprises a sparing table and the error correction code system is configured to detect defective memory sections in the memory device, and the sparing system is configured to update the sparing table with address locations of the detected defective memory sections in the memory device.

8. The data storage and retrieval system of claim 7, where the error correction code system is configured to correct errors in a selected memory section of the memory device, count the errors to obtain an error count and compare the error count to a threshold value to establish if the selected memory section is defective.

9. The data storage and retrieval system of claim 8, where the threshold value is greater than 50% of a power of the error correction code.

10. The data storage and retrieval system of claim 1, where the error correction code system is configured to encode and decode all data stored in the memory device.

11. The data storage and retrieval system of claim 1, where the error correction code system is configured to encode and decode selected data stored in the memory device.

12. The data storage and retrieval system of claim 1, where the error correction code is a Reed-Solomon error correction code.

13. A host computer, comprising:
memory storing instructions to provide an error correction code and to replace defective memory sections of a storage device with spare memory sections of the storage device; and
a processor that executes the instructions to encode and decode data stored in the storage device with the error correction code and to replace addresses of defective memory sections with addresses of spare memory sections, where the addresses of the spare memory sections are provided to the storage device during data transfers between the storage device and the host computer.

14. The host computer of claim 13, where the processor executes instructions to replace addresses before the processor executes instructions to encode and decode data with the error correction code during data transfers.

15. The host computer of claim 13, where the processor executes instructions to encode data with the error correction code before the processor executes instructions to replace addresses during a write operation.

16. The host computer of claim 13, where the processor executes instructions to provide sequential address data transfers between the storage device and the host computer.

17. The host computer of claim 16, where the sequential address data transfers are divided into sub-transfers around addresses of defective memory sections that are replaced with addresses of spare memory sections.

18. The host computer of claim 13, where the memory stores instructions for a digital camera and the processor executes the instructions to perform functions of the digital camera.

19. The host computer of claim 13, where the memory stores instructions for a personal digital assistant and the processor executes the instructions to perform functions of the personal digital assistant.

20. The host computer of claim 13, where the storage device comprises a magnetic random access memory.

21. The host computer of claim 13, where the storage device comprises a phase change random access memory.

22. The host computer of claim 13, where the storage device comprises a probe-based memory.

23. A computer system, comprising:
means for correcting errors in data retrieved from a storage style memory device;
means for identifying defective sections of memory in the storage style memory device, where the defective sections of memory provide more errors than a predetermined threshold value; and
means for sparing the defective sections of memory with replacement sections of memory in the storage style memory device.

24. The computer system of claim 23, where the means for correcting errors comprises a multiple-bit per symbol error correction code.

25. The computer system of claim 23, where the means for correcting errors comprises a single-bit per symbol error correction code.

26. The computer system of claim 23, where the means for identifying comprises:
means for counting the number of errors in a selected section of memory in the storage style device;
means for comparing the number of errors to the predetermined threshold value to obtain a compare result; and
means for indicating if the selected section of memory is defective based on the compare result.

27. The computer system of claim 23, where the means for identifying comprises:
means for storing an address location of one of the defective sections; and
means for storing an address location of one of the replacement sections, where the address location of one of the replacement sections corresponds to the address location of one of the defective sections.

28. The computer system of claim 27, where the means for sparing comprises means for replacing the address location of one of the defective sections with the corresponding address location of one of the replacement sections during data transfers between the computer system and the storage style memory device.

29. A computer-readable medium having computer-executable instructions for performing a method comprising:
replacing addresses for defective memory sections in a memory device with addresses for replacement memory sections in the memory device;
providing the addresses for the replacement memory sections to the memory device during read and write operations with the memory device;
encoding original data with an error correction code to write encoded data into the memory device; and
decoding data retrieved from a selected memory section of the memory device with the error correction code.

30. The method of claim 29, comprising:
maintaining a table of the addresses for defective memory sections and the addresses for replacement memory sections; and
searching the table to match original addresses with the addresses for defective memory sections.

31. The method of claim 29, comprising:
updating a table with new addresses for defective memory sections; and
assigning new addresses for replacement memory sections that correspond with the new addresses for defective memory sections.

32. The method of claim 29, comprising:
counting errors in the data retrieved from the selected memory section to obtain an error count;
comparing the error count to error correction capabilities of the error correction code; and
indicating the selected memory section is defective if the number of errors exceeds a predetermined portion of the error correction capabilities.

33. A method for storing and retrieving data, comprising:
providing a host computer and a storage style memory device;
providing computer-executable sparing instructions and error correction code instructions;
sparing out sections of memory in the storage style memory device by executing the sparing instructions on the host computer; and
encoding and decoding data stored in the storage style memory device with an error correction code by executing the error correction code instructions on the host computer.

34. The method of claim 33, comprising:
detecting grown defective sections of memory in the storage style memory device; and
sparing out the detected grown defective sections of memory.

35. The method of claim 33, comprising:
encoding only selected data; and
decoding only the encoded data stored in the storage style memory device.
